(19) United States
(12) Patent Application Publication
(10) Pub. No.: US 2020/0095163 A1
(43) Pub. Date: Mar. 26, 2020

(54) Thin glass article with a non-uniformly ion-exchanged surface layer and method for producing such a thin glass article

(71) Applicant: SCHOTT GLASS TECHNOLOGIES (SUZHOU) CO. LTD., Jiangsu (CN)

(72) Inventors: Xiaodong LUO, Jiangsu (CN); Chong WANG, Jiangsu (CN); Pengxiang QIAN, Shanghai (CN); Feng HE, Jiangsu (CN); Aiming HUANG, Jiangsu (CN); Dengke HOU, Jiangsu (CN); Rainer LIEBALD, Nauheim (DE); Jose ZIMMER, Losheim am See (DE)

(73) Assignee: SCHOTT GLASS TECHNOLOGIES (SUZHOU) CO. LTD., Jiangsu (CN)

(21) Appl. No.: 16/696,497

(22) Filed: Nov. 26, 2019

Related U.S. Application Data
(62) Division of application No. 15/710,225, filed on Sep. 20, 2017.
Application No. 15/710,225 is a continuation of application No. PCT/CN2015/074681, filed on Mar. 20, 2015.

(51) Int. Cl. C03C 21/00; C03C 17/23; C03C 3/093; C03C 3/087

(52) U.S. Cl. CPC C03C 21/002; C03C 21/008; C03C 17/23; C03C 2217/231; C03C 3/087; C03C 21/005; C03C 2218/34; C03C 3/093

(57) ABSTRACT

A thin glass article is provided that has a first face, a second face, one or more edges joining the first and second faces, and a thickness between the first and second faces, where the faces and the one or more edges together form an outer surface of the thin glass article. The thin glass article has an ion-exchanged surface layer on its outer surface. The ion-exchanged surface layer is non-uniform, wherein the non-uniform ion-exchanged surface layer has an associated compressive surface stress which varies between a minimum and a maximum value over the outer surface and/or a depth of layer which varies between a minimum and a maximum value over the outer surface. A method for producing a thin glass article and a use of a thin glass article are also provided.

### CROSS REFERENCE TO RELATED APPLICATIONS

This application is a divisional of U.S. application Ser. No. 15/710,225 filed Sep. 20, 2017, which is a continuation of International Application No. PCT/CN2015/074681 filed Mar. 20, 2015, the entire contents of both of which are incorporated herein by reference.

### BACKGROUND

### 1. Field of Invention

The invention concerns a thin, in particular ultrathin, glass article with a first face and a second face, having one or more edges joining the first and the second face and a thickness between the first and the second face, the both faces and the one or more edges together forming an outer surface of the thin glass article, and having an ion-exchanged surface layer on its outer surface. The invention further concerns a method for producing a thin, in particular ultrathin, glass article comprising the steps of providing a thin glass sheet with a first face and a second face, having one or more edges joining the first and the second face, a thickness between the first and the second face, wherein the first and the second face together with the one or more edges form an outer surface of the thin glass sheet, and applying an ion-exchange treatment to the thin glass sheet to produce the thin glass article. The invention further concerns a use of said thin glass article.

### 2. Description of Related Art

The market of consumer electronics requires thinner and thinner glass articles to keep minimizing the volume and weight of the final product. In addition, it is a constant requirement, in particular in respect of wearable devices as e.g. smart phones or tablets, to provide glass articles with very high bending strengths and durability which can resist the mechanical stress and impacts occurring during daily use. In view of the desired reduction in volume and weight, there is a demand for thin and even ultrathin glass articles which have the necessary strength and flexibility e.g. for sufficient protection of the underlying components. Moreover, more and more applications require shaped glass articles that allow e.g. for curved designs rather than flat surfaces as e.g. panoramic TV-screens or fingerprint sensors but also applications as e.g. described in US 2012/286302 (OLED lighting), US 2013/148073 (OLED displays) or US 2010/102830 (capacitors). In addition, in particular in the field of communications technology, minimized and versatile optical components are required that allow for controlling light as e.g. optical grids, lenses or diffusors. Such components shall be provided at low cost in order to render the final products achievable for a broad range of consumers.

When the thickness of the glass article is less than approx. 0.4 mm, it becomes flexible and can be bent into desired shapes. With decreasing thickness, however, the thin or ultrathin glass also becomes more fragile, causing easy breakage during handling and processing as compared to thicker glasses. It is therefore common to chemically strengthen thin glasses as described in e.g. US 2014/050911 and US 2010/119846.

The inherent flexibility of thin glass articles allows for their application in a bent state i.e. the flexible thin glass is brought into a bent shape and fixed in this configuration. Thin glasses are thereby superior to the known plastic materials since they provide e.g. better light transmittance, better hardness, better resistance to water vapor and better anti-aging performance. The fragility of thin glass articles, however, limits their application. Unavoidable inherent defects that form either on the edge of the thin glass during the cutting process or on its surface during production will, after a certain time, lead to glass breakage. When a thin glass sheet is brought into a bent state, extra stress is applied on its edges and surfaces which will induce the already present defects to propagate and grow quicker, ultimately causing the thin glass to break sooner. The lifetime of such applications of thin glasses is therefore very limited.

Although the static fatigue for bent thin glass is inevitable, it has been known that the lifetime of thin glasses can be prolonged by improvements e.g. during processing of the glass, production of the glass, cutting technology and chemical toughening technology. For example, the thin glass can be consolidated by laminating or depositing a protective film on its edges (WO 2011/014606, WO 2010/110002, US 2010/260964). Furthermore, the edges and or surfaces can be polished or etched in order to reduce and smooth defects. Although these methods can be advantageous for the handling and processing of thin glasses, they have limited contribution for increasing lifetime of a thin glass in a static bent state.

### SUMMARY

It is therefore a requirement to improve the resistance of thin glass sheets to static fatigue in a bent state as well as to facilitate processing and handling of thin glasses during manufacture, pre- and post-processing.

It is an object of the invention to provide a thin, in particular an ultrathin, glass article and a method for producing such a thin glass article, which overcome the disadvantages of the prior art. In particular, it is the object of the invention to provide a thin glass article which can be easily and cost effectively produced and a method for producing such a thin glass article. It is another object of the invention to provide a thin glass article with a wide range of applications, in particular for the use in electronic devices and as optical device, and a method for producing such a thin glass article. It is another object of the invention to provide a thin glass article with increased control of optical and structural properties and a method for producing such a thin glass article. It is another object of the invention to provide a thin glass article and a method for producing such a thin glass article that allow for a high yield, in particular during processing of the thin glass article. It is a further object of the invention to provide a thin glass article and a method for producing such a thin glass article that has a high durability, in particular under mechanical stress, and a high resistance against static fatigue.

The following terminologies and abbreviations are adopted herein:

The term “glass article” is used in its broadest sense to include any object made of glass, ceramics and/or glass ceramics. As used herein, “thin glass” refers to glasses and glass sheets or articles with a thickness of typically equal or less than 1 mm and “ultrathin” refers to thicknesses equal or less than 0.4 mm, unless otherwise specified. Glass compositions optimized for thin and ultrathin forming and applications requiring thin glasses are e.g. described in WO2014139147.

Compressive stress (CS): A compressive stress that is induced in the glass network in a surface layer by ion-exchange which is sustained as additional stress in the glass network of the surface layer. CS can be measured by the commercially available stress measuring instrument FSM6000 based on an optical principle.

Depth of layer (DoL): The thickness of the ion-exchange surface layer. DoL can be measured by the commercially available stress measuring instrument FSM6000 based on an optical principle.

The objects of the invention are solved by a thin, in particular ultrathin, glass article and a method for producing a thin, in particular ultrathin, glass article. Further, the objects of the invention are solved by the use of the thin or ultrathin glass article.

The thin, in particular ultrathin, glass article according to the invention has a first face and a second face, having one or more edges joining the first and the second face and a thickness between the first and the second face, where the both faces and the one or more edges together form an outer surface of the thin glass article. The thin glass article has an ion-exchanged surface layer on its outer surface. The thin glass article is characterized in that the ion-exchanged surface layer is non-uniform, wherein the non-uniformly ion-exchanged surface layer has an associated compressive surface stress which varies between a minimum and a maximum value over the outer surface and/or a depth of layer which varies between a minimum and a maximum value over the outer surface.

It is well-known that glasses with specific compositions of alkali oxide or alumina can be chemically toughened i.e. stressed by ion-exchange. Thereby, ions on the glass surface as e.g. Na⁺ are exchanged by larger ions as e.g. K⁺ from an ion-exchange bath or medium. As a result, a surface compressive stress layer is formed on i.e. directly below the glass surface. The surface compressive stress CS and the depth of the layer DoL can be controlled by the ion-exchange parameters. Thin glass articles with uniform ion-exchanged surface layers are well known in the art in order to improve mechanical strength.

The invention is based on the surprising insight that mechanical strength, optical properties and shape of a thin glass article can easily be controlled by introducing a non-uniform ion-exchanged surface layer to a thin glass sheet in order to produce the thin glass article according to the invention.

The non-uniform ion-exchanged surface layer according to the invention allows e.g. for introducing an unbalanced surface compressive stress such that the thin glass sheet experiences an intrinsic bending force exerted by the asymmetric stress, resulting in a curved thin glass article. The curvature is thereby associated with the difference in the compressive stress on the two opposing faces and the thickness of the thin glass article. The relation between the curvature radius R, the difference

$$Δσ = \frac{\int Δ CS \cdot Δ DoL dxdydz}{\frac{t}{2}} ,$$

the thickness (t) and Young's Modulus (E) can be expressed as follows:

$$R = \frac{tE}{2 Δσ}$$

If a surface compressive stress is only induced on one of the faces without a surface compressive stress on the other face, Δσ becomes σ, where σ is the value on the face of the glass article that has a non-vanishing surface compressive stress. Constant surface compressive stress on only one face of the thin glass article leads to a curved glass article with essentially constant curvature. Alternating surface areas with different surface compressive stresses can e.g. yield a thin glass article with a corrugated or wavy shape. It becomes immediately evident that shaping a thin glass article by non-uniform ion-exchange, i.e. the associated non-uniform surface compressive stresses and/or depth of layers, allows for a wide variety of novel applications for thin glass articles.

An advantage of the invention is therefore based on the insight that the thin glass sheet can selectively be brought into a desired shape i.e. curved by introducing a non-uniformly ion-exchanged surface layer and thus different associated surface stresses and/or depth of layers. The bending profile and curvature radius of the thin glass are controlled and maintained by the difference of compressive stress and/or depth of layer between its two surfaces. Compared with the bending caused by external stress, such an intrinsic bending will not promptly increase the size of defects on the edges and surfaces, hence increasing the resistance to static fatigue and leading to an extended lifetime of the thin glass for applications with curved glasses.

Another advantage of the invention is based on the insight that a change in refractive index resulting from a non-uniformly ion-exchanged surface layer can be used to render the glass article an optical device as e.g. an optical grid, an optical lens or an optical diffusor. The thin glass article can e.g. be provided with a non-uniformly ion-exchanged surface layer with alternating areas with and without exchanged ions. The non-uniformly ion-exchanged surface layer can have e.g. a stripe pattern or concentric circles in order to provide the glass article with the properties of a linear or circular optical grid or lens.

Another advantage of the invention is based on the insight that selectively stressing the edges of a thin glass sheet by ion-exchange can efficiently reduce the fracture probability of the thin glass by minimizing the negative effects of edge defects as e.g. micro-cracks during processing. Compared to the usually applied whole surface stressed thin glass sheets, such “edge-stressing” has the advantage that e.g. warping issues arising from the stressing process, unexpected refractive index distortions and problems during cutting of the stressed glass sheets can be avoided. Edge-stressing can be combined with prior “edge-smoothing” by e.g. etching or polishing of the edges in order to further decrease the probability of fracture during processing. The thin glass article according to the invention can therefore provide a high yield during manufacture, handling, pre- and post-processing, in particular cleaning, by selective application of a ion-exchange treatment to the edge or edges of the glass article.

In summary, introducing a non-uniform ion-exchanged surface layer in a thin glass sheet according to the invention offers a simple and cost effective way to systematically control mechanical strength during processing as well as optical properties and shape of a thin glass article.

The glass of the thin glass article preferably comprises an alkali containing glass composition. Preferred glasses are e.g. lithium aluminosilicate glasses, soda-lime glasses, borosilicate glasses, alkali metal aluminosilicate glasses, and aluminosilicate glass with low alkali content. Such glasses can be produced by e.g. drawing as e.g. down-draw processes, overflow-fusion or float processes. These glasses are particularly suitable for an ion-exchange treatment. In a preferred embodiment, the ultrathin glass article comprises a lithium aluminosilicate glass with the following composition in weight-%:

| Composition | weight-% |
|---|---|
| SiO₂ | 55-69 |
| Al₂O₃ | 18-25 |
| Li₂O | 3-5 |
| Na₂O + K₂O | 0-30 |
| MgO + CaO + SrO + BaO | 0-5 |
| ZnO | 0-4 |
| TiO₂ | 0-5 |
| ZrO₂ | 0-5 |
| TiO₂ + ZrO₂ + SnO₂ | 2-6 |
| P₂O₅ | 0-8 |
| F | 0-1 |
| B₂O₃ | 0-2 |

Preferably, the lithium aluminosilicate glass comprises the following glass composition in weight %:

| Composition | weight-% |
|---|---|
| SiO₂ | 57-66 |
| Al₂O₃ | 18-23 |
| Li₂O | 3-5 |
| Na₂O + K₂O | 3-25 |
| MgO + CaO + SrO + BaO | 1-4 |
| ZnO | 0-4 |
| TiO₂ | 0-4 |
| ZrO₂ | 0-5 |
| TiO₂ + ZrO₂ + SnO₂ | 2-6 |
| P₂O₅ | 0-7 |
| F | 0-1 |
| B₂O₃ | 0-2 |

Further preferably, the lithium aluminosilicate glass comprises the following glass composition in weight %:

| Composition | weight-% |
|---|---|
| SiO₂ | 57-63 |
| Al₂O₃ | 18-22 |
| Li₂O | 3.5-5 |
| Na₂O + K₂O | 5-20 |
| MgO + CaO + SrO + BaO | 0-5 |
| ZnO | 0-3 |
| TiO₂ | 0-3 |
| ZrO₂ | 0-5 |
| TiO₂ + ZrO₂ + SnO₂ | 2-5 |
| P₂O₅ | 0-5 |
| F | 0-1 |
| B₂O₃ | 0-2 |

In another preferred embodiment, the ultrathin glass article comprises a soda-lime glass with the following composition in weight-%:

| Composition | weight-% |
|---|---|
| SiO₂ | 40-81 |
| Al₂O₃ | 0-6 |
| B₂O₃ | 0-5 |
| Li₂O + Na₂O + K₂O | 5-30 |
| MgO + CaO + SrO + BaO + ZnO | 5-30 |
| TiO₂ + ZrO₂ | 0-7 |
| P₂O₅ | 0-2 |

Preferably, the soda-lime glass comprises the following glass composition in weight-%:

| Composition | weight-% |
|---|---|
| SiO₂ | 50-81 |
| Al₂O₃ | 0-5 |
| B₂O₃ | 0-5 |
| Li₂O + Na₂O + K₂O | 5-28 |
| MgO + CaO + SrO + BaO + ZnO | 5-25 |
| TiO₂ + ZrO₂ | 0-6 |
| P₂O₅ | 0-2 |

Further preferably, the soda-lime glass comprises the following glass composition in weight %:

| Composition | weight-% |
|---|---|
| SiO₂ | 55-76 |
| Al₂O₃ | 0-5 |
| B₂O₃ | 0-5 |
| Li₂O + Na₂O + K₂O | 5-25 |
| MgO + CaO + SrO + BaO + ZnO | 5-20 |
| TiO₂ + ZrO₂ | 0-5 |
| P₂O₅ | 0-2 |

In another preferred embodiment, the ultrathin glass article comprises a borosilicate glass with the following composition in weight-%:

| Composition | weight-% |
|---|---|
| SiO₂ | 60-85 |
| Al₂O₃ | 0-10 |
| B₂O₃ | 5-20 |
| Li₂O + Na₂O + K₂O | 2-16 |
| MgO + CaO + SrO + BaO + ZnO | 0-15 |
| TiO₂ + ZrO₂ | 0-5 |
| P₂O₅ | 0-2 |

Preferably, the borosilicate glass comprises the following composition in weight-%:

| Composition | weight-% |
|---|---|
| SiO₂ | 63-84 |
| Al₂O₃ | 0-8 |
| B₂O₃ | 5-18 |
| Li₂O + Na₂O + K₂O | 3-14 |
| MgO + CaO + SrO + BaO + ZnO | 0-12 |
| TiO₂ + ZrO₂ | 0-4 |
| P₂O₅ | 0-2 |

Further preferably, the borosilicate glass comprises the following composition in weight-%:

| Composition | weight-% |
|---|---|
| SiO₂ | 63-83 |
| Al₂O₃ | 0-7 |
| B₂O₃ | 5-18 |
| Li₂O + Na₂O + K₂O | 4-14 |
| MgO + CaO + SrO + BaO + ZnO | 0-10 |
| TiO₂ + ZrO₂ | 0-3 |
| P₂O₅ | 0-2 |

In another preferred embodiment, the ultrathin glass article comprises an alkali metal aluminosilicate glass with the following composition in weight-%:

| Composition | weight-% |
|---|---|
| SiO₂ | 40-75 |
| Al₂O₃ | 10-30 |
| B₂O₃ | 0-20 |
| Li₂O + Na₂O + K₂O | 4-30 |
| MgO + CaO + SrO + BaO + ZnO | 0-15 |
| TiO₂ + ZrO₂ | 0-15 |
| P₂O₅ | 0-10 |

Preferably, the alkali metal aluminosilicate glass comprises the following composition in weight-%:

| Composition | weight-% |
|---|---|
| SiO₂ | 50-70 |
| Al₂O₃ | 10-27 |
| B₂O₃ | 0-18 |
| Li₂O + Na₂O + K₂O | 5-28 |
| MgO + CaO + SrO + BaO + ZnO | 0-13 |
| TiO₂ + ZrO₂ | 0-13 |
| P₂O₅ | 0-9 |

Further preferably, the alkali metal aluminosilicate glass comprises the following composition in weight-%:

| Composition | weight-% |
|---|---|
| SiO₂ | 55-68 |
| Al₂O₃ | 10-27 |
| B₂O₃ | 0-15 |
| Li₂O + Na₂O + K₂O | 4-27 |
| MgO + CaO + SrO + BaO + ZnO | 0-12 |
| TiO₂ + ZrO₂ | 0-10 |
| P₂O₅ | 0-8 |

In another preferred embodiment, the ultrathin glass article comprises an aluminosilicate glass with low alkali content with the following composition in weight-%:

| Composition | weight-% |
|---|---|
| SiO₂ | 50-75 |
| Al₂O₃ | 7-25 |
| B₂O₃ | 0-20 |
| Li₂O + Na₂O + K₂O | 0-4 |
| MgO + CaO + SrO + BaO + ZnO | 5-25 |
| TiO₂ + ZrO₂ | 0-10 |
| P₂O₅ | 0-5 |

Preferably, the aluminosilicate glass with low alkali content comprises the following composition in weight-%:

| Composition | weight-% |
|---|---|
| SiO₂ | 52-73 |
| Al₂O₃ | 7-23 |
| B₂O₃ | 0-18 |
| Li₂O + Na₂O + K₂O | 0-4 |
| MgO + CaO + SrO + BaO + ZnO | 5-23 |
| TiO₂ + ZrO₂ | 0-10 |
| P₂O₅ | 0-5 |

Further preferably, the aluminosilicate glass with low alkali content comprises the following composition in weight-%:

| Composition | weight-% |
|---|---|
| SiO₂ | 53-71 |
| Al₂O₃ | 7-22 |
| B₂O₃ | 0-18 |
| Li₂O + Na₂O + K₂O | 0-4 |
| MgO + CaO + SrO + BaO + ZnO | 5-22 |
| TiO₂ + ZrO₂ | 0-8 |
| P₂O₅ | 0-5 |

The glasses used in the invention, in particular the above mentioned glasses, can also be modified. For example, the color can be modified by adding transition metal ions, rare earth ions as e.g. Nd₂O₃, Fe₂O₃, CoO, NiO, V₂O₅, MnO₂, TiO₂, CuO, CeO₂, Cr₂O₃. Inclusion of such modifying colorant can e.g. enrich the design of consumer electronics such as color requirements for back covers or can provide an additional function for the ultrathin glass article as e.g. as color filters. In addition, luminescence ions, such as transition metals and rare earth ions can be added in order to endow optical functions, such as optical amplifiers, LEDs, chip lasers etc. In particular, 0-5 weight-% of rare earth oxides can be added to introduce magnetic, photon or optical functions. Moreover, refining agents as e.g. As₂O₃, Sb₂O₃, SnO₂, SO₃, Cl, F, and/or CeO₂ can be added into the glass compositions in amounts of 0-2 weight-%.

The glass article can also be provided with an anti-microbial function by applying an ion-exchange of the glass article in an Ag⁺-containing salt bath or a Cu²⁺-containing salt bath. After the ion-exchange the concentration of Ag⁺ or Cu²⁺ is higher than 1 ppm, preferably higher than 100 ppm, and more preferably higher than 1000 ppm. The ultrathin glass with anti-microbial function could be applied for medical equipment such as computer or screen used in hospitals and consumer electronics with anti-microbial function.

It is to be understood that the sum of the components of the glass composition amounts to 100 weight-%. Further preferred variations of such glasses can be found in e.g. WO2014139147 and are hereby incorporated by reference.

In a preferred embodiment, the deviation in the surface compressive stress and/or depth of layer from the respective mean values of the non-uniformly ion-exchanged surface layer according to the invention is larger than the inherent variations that occur during uniform ion-exchange treatments in the art. Correspondingly, the deviation from a mean value of the non-uniformly ion-exchanged surface layer according to the invention is larger than 5%.

Preferably, the surface compressive stress of the non-uniform ion-exchanged surface layer varies over the outer surface such that the minimum value is at most 90% of the maximum value, preferably at most 50%, further preferably at most 30%, wherein the minimum value of the surface compressive stress can also vanish. In a preferred embodiment, the depth of layer varies over the outer surface such that the minimum value is at most 90% of the maximum value, preferably at most 50%, further preferably at most 30%, wherein the minimum value of the depth of layer can also vanish. If the minimum value vanishes, non-uniformity can be maximized which can e.g. be advantageous if a small curvature radius shall be introduced into the thin glass article or a large difference in refractive index shall be achieved. In another preferred embodiment, the non-uniform ion-exchanged surface layer is such that areas having a deviation from an average surface compressive stress of 30% or more cover equal or more than 15% of the outer surface and/or areas having a deviation from the average depth of layer of 15% or more cover equal or more than 15%.

Whereas different kinds of ions can be exchanged, the non-uniform ion-exchanged surface layer is preferably formed by exchanged K⁺ and/or Na⁺ ions. As the case may be, if e.g. a strongly varying refractive index shall be achieved, exchange of other ions as e.g. Silver (Ag), Thallium (Tl), Lithium (IA), Rubidium (Rb) and/or Cesium (Cs) can be advantageous. Li can e.g. be used to reduce the refractive index whereas e.g. Ag and Tl can largely increase the refractive index by up to 0.1.

A preferred embodiment has a maximum value for the depth of layer of equal or less than 50 μm, preferably equal or less than 30 μm, further preferably equal or less than 20 μm, further preferably equal or less than 10 μm, and further preferably equal or less than 3 μm. The maximum value of the surface compressive stress preferably lies in the range from 10 MPa to 1200 MPa, preferably in the range from 100 MPa to 1200 MPa. These values have proven to be most advantageous for a thin glass article according to the invention. The thickness of the thin glass article thereby can be equal or less than 1 mm, further preferably equal or less than 0.4 mm, further preferably equal or less than 0.2 mm, and further preferably equal or less than 0.1 mm. Selected preferred thicknesses are 5 μm, 10 μm, 15 μm, 25 μm, 30 μm, 35 μm, 50 μm, 55 μm, 70 μm, 80 μm, 100 μm, 130 μm, 145 μm, 160 μm, 190 μm, 210 μm or 280 μm.

Preferably, the maximum values of depth of layer and surface compressive stress relate to the thickness of the thin glass article according to the following Table 1:

TABLE 1
Preferred relation between thickness, DoL and CS.

| Thickness (mm) | DoL (μm) | CS (MPa) |
|---|---|---|
| 0.3 | ≤50 | ≤700 |
| 0.2 | ≤50 | ≤700 |
| 0.1 | ≤30 | ≤600 |
| 0.07 | ≤25 | ≤400 |
| 0.05 | ≤20 | ≤350 |
| 0.025 | ≤10 | ≤300 |
| 0.01 | ≤3 | ≤300 |

In a preferred embodiment, the thin glass article has one or more surface areas of a first kind and one or more surface areas of a second kind on its outer surface with different surface compressive stress and/or depth of layer in each kind of surface areas. “Different” herein e.g. refers to the surface compressive surface stress in one kind of surface areas to be different from the surface areas of the other kind by at least 10% of the larger of the both values, preferably equal or larger than 50%, further preferably equal or larger than 70%, wherein further preferably the surface compressive stress in one kind of surface areas can vanish. “Different” can also refer to the depth of layer in one kind of surface areas to be different from the surface areas of the other kind by at least 10% of the larger of the both values, preferably equal or larger than 50%, further preferably equal or larger than 70%, wherein further preferably the depth of layer in one kind of surface areas can vanish. “Different” in the present sense can generally also refer to a difference in another parameter of the ion-exchanged layer as e.g. the type of exchanged ions.

The surface areas of each kind preferably have an essentially constant surface compressive stress and/or depth of layer within the respective area. Essentially constant hereby includes variations of up to 5% as they inherently can occur for uniformly ion-exchanged surface layers due to variations during production. In a preferred embodiment, the surface compressive stress and/or the depth of layer correspond to the respective maximum value in the first kind of surface areas and to the respective minimum value in the second kind of surface areas. Alternatively, the surface areas of the second kind can e.g. have values between the respective minimum and maximum values and e.g. further kinds of surface areas can be present with other values of the surface compressive stress and/or depth of layer.

CS(x) and DoL(x) as functions of an outer surface coordinate x are to be understood to change rather abruptly in the case of the surface areas of the first and second kind at the boundaries of the respective surface areas i.e. on small length scales as compared to the dimension of the surface areas. The surface areas of such embodiments are therefore rather sharply defined. In alternative embodiments, e.g. without surface areas of the first and second kind, the surface compressive stress and/or the depth of layer can smoothly and continuously vary over the outer surface i.e. CS(x) and/or DoL(x) vary on rather large length scales as e.g. compared to the dimension of the thin glass article.

In a preferred embodiment of the invention, the one or more areas of the first kind cover equal or more than 15% of the outer surface of the thin glass article, preferably equal or more than 30% and further preferably equal or more than 50% of the outer surface.

In a further preferred embodiment of the thin glass article, the one or more areas of the first kind cover at least one of the faces of the thin glass article at least partially. The partial coverage can thereby be provided by a regular or irregular pattern of arbitrarily shaped surface areas as e.g. stripes or squares. In a further preferred embodiment, a surface area of the first kind completely covers one of the faces of the thin glass article whereas a surface area of the second kind completely covers the other face.

In another preferred embodiment of the invention, the one or more areas of the first kind cover the one or more edges of the thin glass article at least partially. Thereby, a selective strengthening of the edge or edges of the glass article can be achieved. In a preferred embodiment, the surface areas of the first kind cover the edge or edges completely. It can thereby be advantageous that the areas of the first kind cover the edge or edges whereas the surface areas of the second kind mostly cover the faces of the thin glass article. The surface areas of the first kind can thereby extend in a border area onto the faces of the thin glass article to ensure full coverage of the edges. In other words, the edge or edges are selectively toughened by the ion-exchange layer. It has been found that the selective toughening of the edges can sufficiently increase the mechanical strength of the thin glass article with greatly reduced risk of breakage and thus can increase the yield during processing.

The one or more areas of the first kind can have a regular shape, preferably a polygonal or an elliptic shape, wherein the polygonal shape preferably is a rectangle, further preferably a square, and wherein the elliptical shape preferably is a circle. These and similar shapes are rather simple and can be easily produced. According to the specific requirements, other shapes as e.g. irregular shapes can also be preferred if, for example, the areas of the first kind need to be adapted to a particular shape of the glass article.

For many applications, it is preferred that the thin glass article has several areas of the first kind on its outer surface. “Several areas” hereby refers to essentially disconnected surface areas of one kind of the thin glass article that are separated by one or more areas of another kind, in particular the second kind. “Essentially disconnected” includes arrangements where two areas touch only in a point as e.g. the squares of a chess-board pattern. Preferably, the several areas of the first kind cover part of one or both faces of the thin glass article. In other words, the several areas of the first kind can either be located on only one or on both of the faces.

In a preferred embodiment, the several areas of the first kind are each fully surrounded by an area of the second kind i.e. are completely disconnected. Preferably, the several areas of the first kind have a congruent shape, i.e. the same size and the same shape. The several areas can be arranged in a regular pattern on the face or the faces of the thin glass article, wherein the pattern is preferably a chess-board pattern, a stripe pattern, a circle pattern, or a wave pattern. Regular patterns can be used to realize e.g. periodic patterns for optical gratings or to create periodic shapes of the thin glass article as e.g. corrugated or wavy shapes. It is, however, evident that other shapes as e.g. irregular shapes and/or irregular patterns can also be advantageous, dependent on the specific requirements.

In a preferred embodiment, each area of the first kind arranged on one of the faces of the thin glass is opposed by a corresponding area of the second kind on the opposing face of the thin glass article. This is particularly advantageous if the inhomogeneous ion-exchanged surface layers are used to shape the thin glass article since the surface compressive stress induced in the areas of the first kind is opposed by e.g. a lesser or no surface compressive stress in the areas of the second kind. In case of e.g. an optical grating, it can be advantageous if each area of the first kind on the one face is opposed by another area of the first kind on the other face in order to increase the optical effect.

In a preferred embodiment of the invention, the thin glass article has at least one curved region with a surface curvature resulting from the non-uniformly ion-exchanged surface layer, in particular from an unbalanced surface compressive stress associated with the non-uniformly ion-exchanged surface layer. The at least one curved region can have a minimal curvature radius in the range from 1 mm to 1000 mm, preferably from 3 mm to 500 mm. In the case of surface areas of the first and second kind, the at least one curved region can be associated with at least one of the surface areas of the first kind.

In a preferred embodiment of the invention, the thin glass article has exactly one curved region extending over the whole thin glass article, preferably having an essentially constant, in particular cylindrical curvature. In this case, the thin glass article has one area of the first kind and one area of the second kind which each completely covers one of the faces of the thin glass article. Preferably, the area of the second kind has a vanishing surface compressive stress. The constant compressive surface stress resulting from the exchanged ions in the area of the first kind thereby induces the curvature extending over the whole glass article. In a variant, the surface compressive stress in the area of the first kind can also smoothly vary in order to produce a desired profile of the surface compressive stress for achieving e.g. a parabolic, hyperbolic, or another curvature as required.

In another preferred embodiment of the invention, the thin glass article has several curved regions, wherein the curved regions preferably have alternating senses of curvature as e.g. in a corrugated or wave shape. The curved regions thereby can be associated with the areas of the first kind which are e.g. arranged in a stripe pattern on both faces of the thin glass article.

In another preferred embodiment, particularly for the use as optical device, the non-uniformly ion-exchanged surface layer is such that a resulting refractive index varies by at least 0.001 up to 0.1 across the thin glass article, in particular between the one or more areas of the first and the second kind, preferably by at least 0.004 to 0.009. The thin glass article can have the function of an optical grating (or grid) resulting e.g. from a pattern of the surface areas of the first and second kind. The pattern of the surface areas thereby usually has a regular periodic structure as e.g. equidistant stripes or concentric circular rings.

A linear optical grid e.g. splits and diffracts light into several modes propagating in different directions. The directions of the modes depend on the spacing of the grating and the wavelength of the light. According to the invention, the thin glass article has a non-uniformly ion-exchanged layer that can be embodied as a pattern of stripe shaped areas on the face(s) of the thin glass article. Due to the change in refractive index, the stripe shaped areas of the non-uniformly ion-exchanged surface layer can serve as optical grid. In this case, the characteristic scales of the stripes should be comparable with the wavelength of the corresponding light. The resulting diffraction is then described by the well-known corresponding grating equation

(a+b)sin θₘ=mλ,

where a is the width of the stripes and b is the width of the distance between the stripes, λ the wavelength of the light and θ is the angle between the diffracted ray and the grid's normal and m is the propagation mode of interest. Such gratings can be use in optics as e.g. monochromators or spectrometers, in particular in the field of communications.

Another optical application of the thin glass article according to the invention is an optical diffusor which is used in optics to diffuse or scatter light. To this end, e.g. surface areas of the first kind can be arranged in a regular or irregular array and have regular or irregular shapes. The surface areas of the first kind should thereby have a size on a scale which is comparable to the wavelength of the corresponding light.

The variation in refractive index due to the non-uniform ion-exchanged surface layer can also be employed to imprint information as e.g. a picture or text on the thin glass. In particular, it can be employed to provide e.g. a visually perceptible “watermark” on the thin glass article or a holographic reproduction produced by interference achieved by the varying optical properties. The thin glass article can thereby easily be applied as thin e.g. protective cover with the desired optical properties.

It has been found that the exchange of ions as e.g. Silver (Ag), Thallium (Tl), Lithium (Li), Rubidium (Rb) and/or Cesium (Cs) can induce a comparatively large change in the refractive index of up to 0.1. If the exchanged ions are K⁺ and/or Na⁺, it has been found that the change in the refractive index varies essentially linearly with the depth of layer and the compressive surface stress. The refractive index can be measured by a prism coupler as e.g. Metricon 2010/M.

In another aspect of the invention, a method for producing a thin, in particular ultrathin, glass article is provided, in particular for producing a thin glass article as described herein. The method comprises the steps of providing a thin glass sheet with a first face and a second face, having one or more edges joining the first and the second face, a thickness between the first and the second face, wherein the first and the second face together with the one or more edges form an outer surface of the thin glass sheet. The method further comprises applying an ion-exchange treatment to the thin glass sheet to produce the thin glass article. The method is characterized in that the ion-exchange treatment is non-uniformly applied to the outer surface in order to produce a non-uniformly ion-exchanged surface layer in the thin glass sheet, such that the non-uniformly ion-exchanged surface layer has an associated compressive surface stress which varies between a minimum and a maximum value over the outer surface and/or a depth of layer which varies between a minimum and a maximum value over the outer surface.

The non-uniform ion-exchange treatment is preferably applied such that the minimum value of the surface compressive stress is at most 90% of the maximum value, preferably at most 50%, further preferably at most 30%, wherein the minimum value of the surface compressive stress preferentially vanishes. In another preferred method, the non-uniform ion-exchange treatment is applied such that the minimum value of the depth of layer is at most 90% of the maximum value, preferably at most 50%, further preferably at most 30%, wherein the minimum value of the depth of layer preferentially vanishes.

According to another embodiment, applying the non-uniform ion-exchange treatment to the outer surface includes fully or partially masking areas of the outer surface prior to applying the ion-exchange treatment, preferably by applying a cover or coating to said areas of the outer surface which fully or partially prevents an ion-exchange. Preferably, the masking is removed after the treatment. The masking can be designed to completely prevent an ion-exchange in the masked areas but can also be partially permeable to the ion-exchange. A suitable method for preventing an ion-exchange is masking by coating an indium tin oxide film (ITO-film).

The masking can also be designed such that in some of the masked areas the ion-exchange is more efficient than in other masked areas e.g. by providing a varying permeability to the ions to be exchanged. The masking can also be removed during the ion-exchange treatment in order to achieve different surface compressive stresses and/or depth of layers. The thin glass sheet can also be non-uniformly submerged in a salt bath for exchanging ions in a non-uniform manner. Further, different ion-exchange treatments with e.g. different types of ions can be applied to different areas of the thin glass sheet.

In a preferred embodiment, the non-uniform ion-exchange treatment is selectively applied to one or more designated surface areas on the outer surface in order to produce one or more surface areas of a first kind and one or more surface areas of a second kind, where the surface compressive stress and/or the depth of layer is different in each kind of surface areas. The non-uniform ion-exchange treatment is preferably applied such that the surface compressive stress and/or the depth of layer correspond to the respective maximum value in the first kind of surface areas and to the respective minimum value in the second kind of surface areas. The surface areas of the first kind and the second kind can be arranged in a patterned manner as described in the above.

Preferably, the one or more designated areas at least partially cover one or both of the faces of the outer surface. In another preferred embodiment, the one or more designated areas at least partially, preferably completely, cover the one or more edges of the outer surface.

In a preferred embodiment, the non-uniform ion-exchange treatment includes applying alkaline metal salts to the thin glass sheet, preferably one or more of the following alkaline metal salts: NaNO₃, Na₂CO₃, NaOH, Na₂SO₄, NaF, Na₃PO₄, Na₂SiO₃, Na₂Cr₂O₇, NaCl, NaBF₄, Na₂HPO₄, K₂CO₃, KOH, KNO₃, K₂SO₄, KF, K₃PO₄, K₂SiO₃, K₂Cr₂O₇, KCl, KBF₄, K₂HPO₄, CsNO₃, CsSO₄, CsCl.

The ion-exchange treatment can include fully or partially, in particularly non-uniformly, submerging the thin glass sheet in an alkaline metal salt bath for 15 minutes to 48 hours, preferably at a temperature between 350° C. and 700° C. In addition or alternatively, the non-uniform ion-exchange treatment can include non-uniformly applying a paste containing alkaline metal salts to the outer surface, in particular in the one or more designated areas, and annealing the thin glass sheet in order to drive the ion-exchange. Preferably, the paste is dried at a temperature of 100° C. and 300° C. for 2 to 10 hours prior to annealing. The ion-exchange can then be driven by heating the ultrathin glass to a temperature in the range from 200° C. to 765° C. for 15 minutes to up to 48 hours. After annealing, the remaining powder of the dried paste can be removed.

In a preferred embodiment, the non-uniform ion-exchange treatment includes controlling a slow ion-exchange rate to achieve a non-uniform ion-exchange surface layer with the maximum value of the depth of layer of equal to or less than 50 μm, preferably equal to or less than 30 μm, further preferably equal to or less than 20 μm, further preferably equal to or less than 10 μm, further preferably equal to or less than 3 μm, and the maximum value of the surface compressive stress preferably lies in the range from 10 MPa to 1200 MPa, preferably in the range from 100 MPa to 1200 MPa.

The unbalanced ion-exchange is preferentially achieved by controlling a slow ion-exchange rate during the ion-exchange to achieve the depths of ion-exchanged layer DoL as mentioned, the surface compressive stresses CS as mentioned and a central tensile stress CT (σ_{CT}) of equal or less than 120 MPa, wherein the thickness t, DoL, CS and CT of the toughened ultrathin glass article meet the relationship

$$\frac{0.2 t}{{L}_{DoL}} \leq \frac{{σ}_{CS}}{{σ}_{CT}} .$$

In another preferred embodiment, a curvature is induced in the thin glass sheet due to the surface compressive stress resulting from the non-uniform ion-exchange treatment.

Further embodiments and advantages of the method according to the invention can be gathered from the description of the thin glass article according to the invention herein.

The invention further provides for a use of the a thin, in particular ultrathin, glass article according to the invention and a thin glass article produce by the method of the invention for applications in the field of displays, display covers, in particular OLED displays, OLED lightning, thin film batteries, PCB/CCL, capacitors, E-papers or MEMS/MOEMS, optical devices, preferably as optical diffusors, optical grids or optical lenses, and preferably any other application where σ thin substrate, in particular a thin glass substrate, is used. Further preferred uses include semiconductor packaging, protective member for shaped or curved windows as well as shaped decorative elements. The invention also provides for a use of the a thin, in particular ultrathin, glass article according to the invention and a thin glass article produce by the method of the invention for increasing the production yield by increasing the strength and, according to the specific requirements for the glass article, avoiding unwanted warping of the glass.

### BRIEF DESCRIPTION OF THE DRAWINGS

The exemplary figures used for illustration of the invention schematically show:

FIG. 1 is a thin glass sheet with rectangular shape;

FIGS. 2a-2e are sectional views of several thin glass articles with non-uniform ion-exchanged surface layers according to the invention;

FIGS. 3a-3f are several frontal views of thin glass articles with patterned non-uniform ion-exchanged surface layers according to the invention;

FIG. 4a is a sectional view of a thin glass article with a patterned non-uniform ion-exchanged surface layer on both faces of the glass article;

FIG. 4b is an alternatingly curved thin glass article resulting from the patterned non-uniform ion-exchanged surface layer according to FIG. 4a;

FIG. 5a is a sectional view of a thin glass article with a non-uniformly ion-exchanged surface layer where one face has a constant ion-exchanged surface layer and the other face has a no ion-exchanged surface layer,

FIG. 5b is a thin glass article with constant curvature resulting from the non-uniformly ion-exchanged surface layer according to FIG. 5a;

FIG. 6 is a perspective view of a thin glass article with a non-uniformly ion-exchanged surface layer covering the edges of the glass article.

The dimensions and aspect ratios in the figures are not to scale and have been oversized in part for better visualization. Corresponding elements in the figures are generally referred to by the same reference numerals.

### DETAILED DESCRIPTION

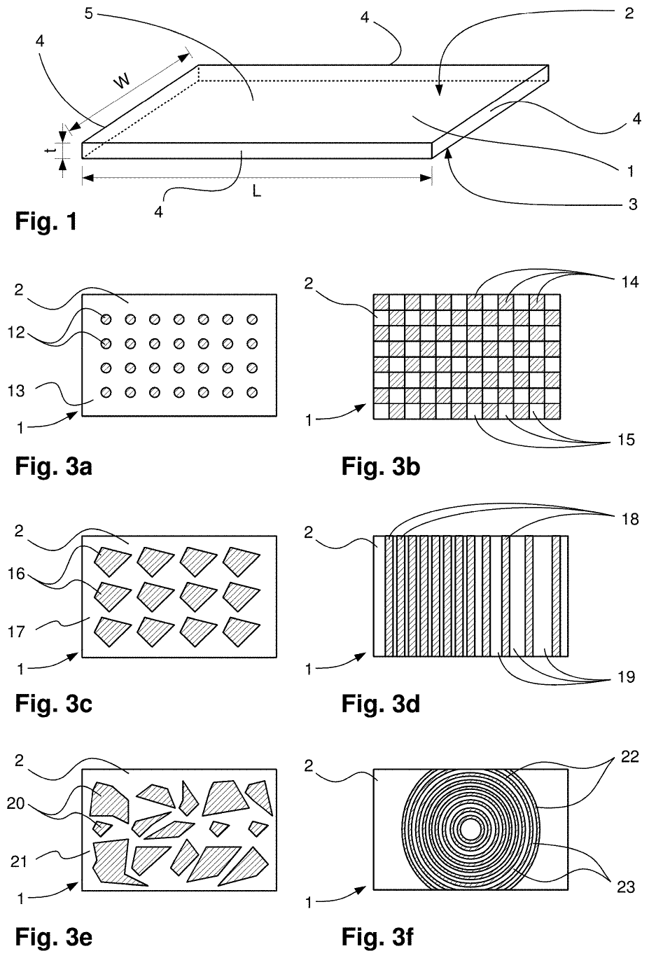

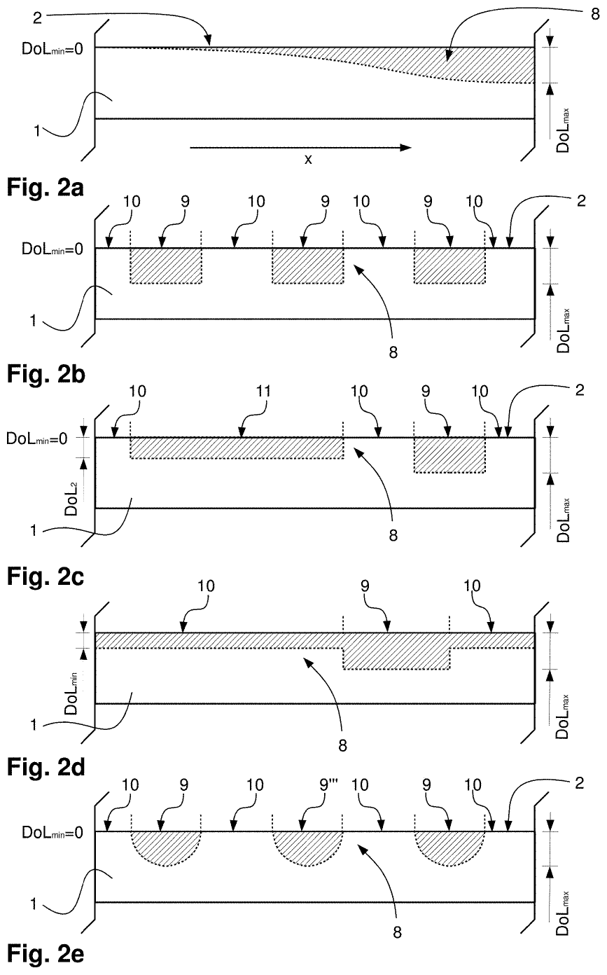

FIG. 1 shows a rectangular shaped thin glass article 1 (henceforth referred to as “glass article 1”) with a length L, a width W and a thickness t. The glass article 1 has a first face 2 and an opposing second face 3 which are joined by four linear edges 4. The faces 2 and 3 together with the edges 4 form an outer surface 5 of the glass article 1. It is to be understood that the glass article can also have other shapes as e.g. a circular shape or any other shape as required by the desired application. According to the invention, the glass article 1 has a non-uniformly ion-exchanged surface layer 8 (henceforth referred to as “surface layer 8”, see e.g. FIG. 2a-2e) which varies over the outer surface 5.

FIGS. 2a-2e show partial sectional views of the glass article 1 with several different surface layers 8 according to the invention. FIGS. 2a-2e do not indicate the surface compressive stress (CS) associated with the surface layers 8 and rely on the depth of layer (DoL) for illustration of the invention. Separators of different surface areas are indicated by thin dashed lines where appropriate.

FIG. 2a shows a continuously varying ion-exchanged layer 8 of the first face 2 of the glass article 1. The ion-exchanged layer 8 varies from a minimal depth of layer DoLₘᵢₙ=0 to a maximum value DoLₘₐₓ. The transition from DoLₘᵢₙ to DoLₘₐₓ extends along a dimension x over a comparatively large distance which can be of the same order of magnitude as a characteristic dimension of the glass article 1.

FIG. 2b shows a regularly patterned surface layer 8 with surface areas 9 of a first kind having a DoL of DoLₘₐₓ whereas surface areas 10 of a second kind have a DoL of DoLₘᵢₙ=0. The surface areas 9 and 10 are arranged in a regularly alternating sequence. The surface areas 9 and 10 directly border to each other in this embodiment and the transition in DoL from the surface areas 9 to the neighboring surface areas 10 is abrupt, i.e. on a length scale that is small compared to the extension of the surface areas 9 and 10. The transition is indicated as a step function in FIG. 2b.

FIG. 2c shows an irregularly patterned surface layer 8 with a surface area 9 of a first kind having a DoL of DoLₘₐₓ, surface areas 10 of a second kind having a DoL of DoLₘᵢₙ=0 and a surface area 11 of a third kind having a DoL of DoL₂ with DoLₘᵢₙ<DoL₂<DoLₘₐₓ.

FIG. 2d shows an irregularly patterned surface layer 8 with a surface area 9 of a first kind having a DoL of DoLₘₐₓ, and surface areas 10 of a second kind having a DoL of DoLₘᵢₙ≠0.

FIG. 2e shows a regularly patterned surface layer 8 with surface areas 9 of a first kind having a DoL varying from DoLₘᵢₙ=0 to DoLₘₐₓ and surface areas 10 of a second kind having a DoL of DoLₘᵢₙ=0.

FIGS. 3a-3e show differently patterned surface layers 8 with surface areas 12, 14, 16, 18, 20, 22 of a first kind (hatched) and surface areas 13, 15, 17, 19, 21, 23 of a second kind (white) on the face 2 of the glass article 1 in a frontal view. It is to be understood that the surface areas 12, 14, 16, 18, 20, 22 can have e.g. a larger DoL and/or CS than the surface areas 13, 15, 17, 19, 21, 23 or vice versa. The patterns shown in FIG. 3a-3e also represent a masking by e.g. a coating used during production of the thin glass article in order to achieve the non-uniform ion-exchanged surface layer 8.

FIG. 3a shows a regular pattern of regular shaped surface areas 12 which are circularly shaped. The surface areas 12 are arranged in an array and are disconnected. The surface areas 12 are fully surrounded by a surface area 13 covering the remaining area of the face 2. The surface areas 12 and 13 together fully cover the face 2. Such a regular pattern can be applied as e.g. optical diffusors.

FIG. 3b shows a regular pattern of regular shaped surface areas 14 and 15 which have a congruent quadratic shape i.e. the same shape and the same size. The surface areas 14 and 15 are alternatingly arranged in a chess-board pattern. The surface areas 14 and 15 together fully cover the face 2. Such chess-board patterns can be applied as e.g. optical diffusors.

FIG. 3c shows a regular pattern of irregularly shaped surface areas 16. The surface areas 16 are arranged in an array and are disconnected. The surface areas 16 are fully surrounded by a surface area 17 covering the remaining area of the face 2. The surface areas 16 and 17 together fully cover the face 2. Such a regular pattern can be applied as e.g. optical diffusors.

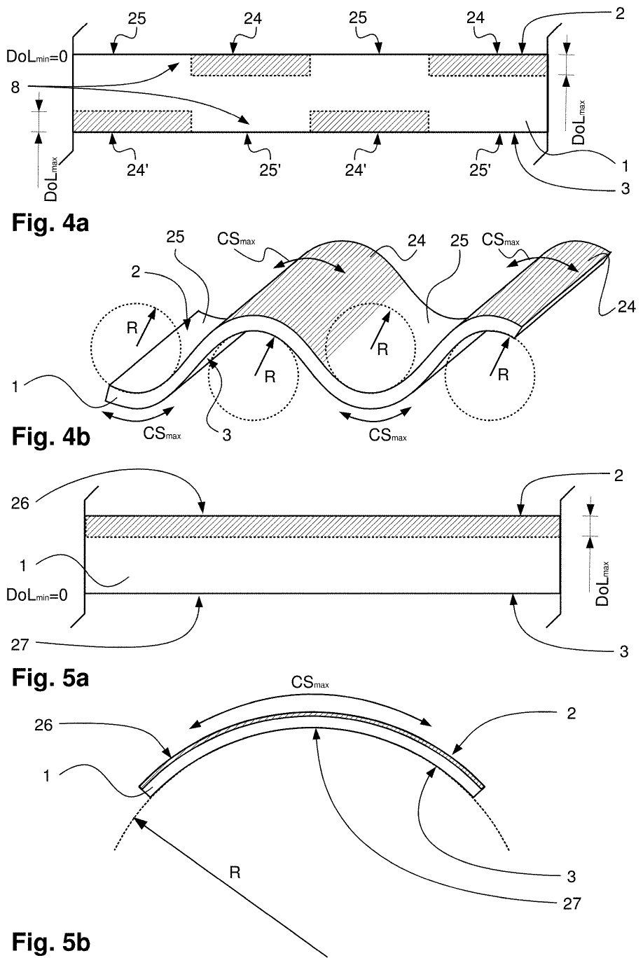

FIG. 3d shows a stripe pattern which is regular in one half of the face 2 (left side) and, for illustration purposes, irregular in the other half. The stripe pattern is formed by stripe shaped surface areas 18 which are separated by also stripe shaped surface areas 19. The surface areas 19 in the regular half have identical width whereas the width is increasing in the irregular half of face 2. The surface areas 18 and 19 together fully cover the face 2. Such stripe patterns can be applied as regular or irregular patterns as e.g. optical grids or linear optical lenses or if a wave shaped glass article is required (see also FIGS. 4a and 4b).

FIG. 3e shows an irregular pattern of irregular shaped surface areas 20. The surface areas 20 are arranged in an array and are disconnected. The surface areas 20 are fully surrounded by a surface area 21 covering the remaining area of the face 2. The surface areas 20 and 21 together fully cover the face 2. Such irregular patterns can e.g. be applied as optical diffusors.

FIG. 3e shows concentric ring shaped surface areas 22 which are separated by correspondingly shaped surface areas 23. The surface areas 22 and 23 together fully cover the face 2. Such a surface layer 8 can e.g. be applied as optical lens or grating.

FIG. 4a shows a partial sectional view of the glass article 1 with another embodiment of the surface layer 8 according to the invention. The surface layer 8 in this embodiment corresponds to a stripe pattern with surface areas 24 of a first kind on the face 2 and surface areas 24′ of a first kind on face 3. The surface areas 24 and 24′ have a DoL=DoLₘₐₓ and a surface compressive stress CS=CSₘₐₓ (see also FIG. 4b). The surface layer 8 further comprises surface areas 25 of a second kind on face 2 and surface areas 25′ of a second kind on face 3. The surface areas 25 and 25′ of the second kind have a DoL=DoLₘᵢₙ=0 and also have a surface compressive stress CS=CSₘᵢₙ=0. The surface areas 24 and 25 are arranged with respect to the surface areas 24′ and 25′ such that each surface area 24 and 24′ on the respective face 2 or 3 is opposed by a surface area 25′ or 25 on the other face, respectively.

FIG. 4b shows a perspective view of the glass article 1 of FIG. 4a in a relaxed state. Due to the compressive surface stresses CS=CSₘₐₓ in the surface areas 24 on face 2 and 24′ on face 3 which are not opposed by any surface compressive stresses on the respective areas on the opposing face, the glass article 1 experiences an unbalanced surface force. If the difference in surface compressive stress ΔCS between the surface areas 24 and the opposing surface areas 25′ (ΔCS=CSₘₐₓ in the present example) is large enough, the glass article 1 experiences a bending force and relaxes into a curved shape until the surface compressive stresses are balanced. Since the glass article 1 of FIGS. 4a and 4b has an alternating stripe pattern, the unbalanced surface compressive stresses result in a wave-like shape of the glass article 1 as shown in FIG. 4b. The curved regions are thereby associated with e.g. the surface areas 24 and 24′ of the first kind and have a (minimal) curvature radius R.

FIG. 5a shows a partial sectional view of the glass article 1 with another embodiment of the surface layer 8 according to the invention. The glass article 1 has a constant DoL=DoLₘₐₓ and an associated surface compressive stress CS=CSₘₐₓ over the whole face 2 or, in other words, a surface area 26 of a first kind that covers the whole face 2. The surface layer 8 has a DoL=DoLₘᵢₙ=0 over the whole opposing face 3 or in other words has a surface area 27 of a second kind that covers the whole face 3. Due to the thus unbalanced surface compressive stresses, i.e. ΔCS≠0, between the both faces 2 and 3, the glass article 1 experiences an unbalanced surface force which causes the glass article 1 to bend into a curved shape until the surface compressive stresses on both faces 2 and 3 are balanced. Since the surface layer 8 is essentially constant on each face, the glass article 1 achieves a shape that has an essentially constant cylindrical curvature R as shown in FIG. 5b.

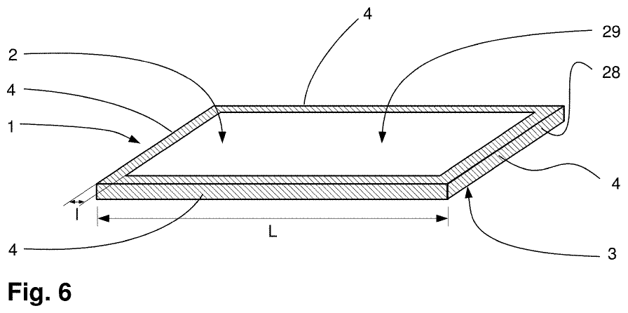

FIG. 6 shows another embodiment of the glass article 1 with a surface layer 8 according to the invention. In this embodiment, the surface layer 8 has a surface area 28 (hatched) of a first kind that covers the edges 4 of the glass article 1 and extends onto the faces 2 and 3 in a border region along the edges 4. The surface area 28 has a DoL=DoLₘₐₓ and a surface compressive stress CS=CSₘₐₓ. The remaining area of the face 2 is covered by a surface area 29 of a second kind and the remaining area of face 3 by a corresponding surface area (not visible in FIG. 6), The surface area 29 has a DoL=DoLₘᵢₙ and a surface compressive stress CS=CSₘᵢₙ. The border regions on the faces 2 and 3 have a width 1. The following values for 1/L, CS and DoL have been found to be particular advantageous combinations:

| 1/L | CS (MPa) | DoL (μm) |
|---|---|---|
| ≤0.3 | ≥20 | ≥5 |
| ≤0.1 | ≥50 | ≥10 |
| ≤0.01 | ≥100 | ≥20 |
| ≤0.001 | ≥300 | ≥50 |

It is, however, to be understood that other combinations can also be advantageous and the particular choice may depend on the specific requirements.

### EXEMPLARY EMBODIMENTS

The glass compositions A and B as listed in the below Table 2 are used for the exemplary embodiments 1-8 as described below:

TABLE 2
Exemplary glass compositions

| | |
|---|---|
| Glass A | Glass B |

| Composition | weight-% | Composition | weight-% |
|---|---|---|---|
| SiO₂ | 64.0 | SiO₂ | 62 |
| B₂O₃ | 8.3 | Al₂O₃ | 17 |
| Al₂O₃ | 4.0 | Na₂O | 13 |
| Na₂O | 6.5 | K₂O | 3.5 |
| K₂O | 7.0 | MgO | 3.5 |
| ZnO | 5.5 | CaO | 0.3 |
| TiO₂ | 4.0 | SnO₂ | 0.1 |
| Sb₂O₃ | 0.6 | TiO₂ | 0.6 |
| Cl⁻ | 0.1 | | |

Glasses A and B have the following selected properties:

TABLE 3
Parameters of glasses A and B according to Table 2

| Parameter | Glass A | Glass B |
|---|---|---|
| CTE (20-300° C.) [10⁻⁶/K] | 7.2 | 8.3 |
| T_{g} [° C.] | 557 | 623 |
| Density [g/cm³] | 2.5 | 2.4 |

CTE in Table 3 refers to the coefficient of thermal expansion and T, refers to the glass transition temperature.

### Example 1

A sheet of 100 mm×60 mm was cut from glass A (see Table 2) with a thickness of 0.05 mm. The glass sheet was pasted with an ink mixed with KNO₃ powder by a screen printing method fully covering one of its faces. Subsequently, the sheet was dried at 180° C. during 1 hour to remove the ink. After drying, the sheet was annealed at 330° C. for 2 hours to drive an ion-exchange process. As a result, the in this example ultrathin glass sheet experienced a bending into a widely cylindrical curved shape with a curvature radius of 52 mm (corresponding to the shape shown in FIG. 5b).

### Example 2

A sheet of 100 mm×60 mm was cut from glass A (Table 2) with a thickness of 0.05 mm. The sheet was coated with an indium tin oxide (ITO) film on one of its faces in order to prevent ion-exchange and was subsequently submersed into a KNO₃ salt bath. The ultrathin glass sheet was toughened at a temperature of 400° C. for 1 hour. The CS is approximately 270 MPa and the DoL is approximately 7 μm. As a result, the in this example ultrathin glass sheet experienced a bending into a widely cylindrical curved shape with a curvature radius of 48 mm (corresponding to the shape shown in FIG. 5b).

### Example 3

A sheet of 100 mm×60 mm was cut from glass A (Table 2) with a thickness of 0.1 mm. The sheet was masked according to the surface areas 24 and 24′ in a regular stripe pattern as shown in FIG. 4a (see also FIG. 3d). The sheet was then coated with an ITO-film, resulting in coated areas corresponding to the surface areas 25 and 25′ in order to prevent ion-exchange in the coated areas. After removing the masking of the surface areas 24 and 24′, the ultrathin glass sheet was submersed into a KNO₃ salt bath and toughened at a temperature of 400° C. for 1 hour. This resulted in an ion-exchange in the surface areas 24 and 24′ and in no ion-exchange in the ITO-coated surface areas 25 and 25′. The CS is approximately 270 MPa and the DoL is approximately 7 μm. As a result, the in this example ultrathin glass sheet experienced an alternating bending into a wave shape as shown in FIG. 4b.

### Example 4

A sheet of 100 mm×60 mm was cut from glass B (Table 2) with a thickness of 0.3 mm. The sheet was masked according to the surface areas 18 in the regular stripe pattern shown in FIG. 3d. The sheet was then coated with an ITO-film, resulting in coated areas corresponding to the surface areas 19 in order to prevent ion-exchange in the coated areas. The widths of all stripe shaped surface areas 18 and 19 were 5 μm. After removing the masking of the surface areas 18, the in this example ultrathin glass sheet was submersed into a KNO₃ salt bath and toughened at a temperature of 420° C. for 3 hours. The CS is approximately 900 MPa and the DoL is approximately 35 μm. The refractive index variation is about 0.008. The resulting ultrathin glass article can be applied as an optical grating.

### Example 5

A sheet of 100 mm×60 mm was cut from glass B (Table 2) with a thickness of 0.3 mm. The sheet was masked according to the surface areas 14 in the chess-board pattern shown in FIG. 3b. The sheet was then coated with an ITO-film, resulting in coated areas corresponding to the surface areas 15 in order to prevent ion-exchange in the coated areas. The edge lengths of all square surface areas 14 and 15 were 5 μm. After removing the masking of the surface areas 14, the in this example ultrathin glass sheet was submersed into a KNO₃ salt bath and toughened at a temperature of 420° C. for 3 hours. The CS is approximately 900 MPa and the resulting DoL is approximately 35 μm. The refractive index variation is about 0.008. The resulting ultrathin glass article can be applied as an optical diffusor.

### Example 6

A sheet of 100 mm×60 mm was cut from glass B (Table 2) with a thickness of 0.3 mm. The sheet was masked according to the surface areas 12 in the circle pattern shown in FIG. 3a. The sheet was then coated with an ITO-film, resulting in a coated area corresponding to the surface area 13 in order to prevent ion-exchange in the coated area. The diameter of each circular surface area 12 was 5 μm. After removing the masking of the surface areas 12, the in this example ultrathin glass sheet was submersed into a KNO₃ salt bath and toughened at a temperature of 420° C. for 3 hours. The CS is approximately 900 MPa and the DoL is approximately 35 μm. The refractive index variation is about 0.008. The resulting ultrathin glass article can be applied as an optical diffusor.

### Example 7

A sheet of 100 mm×60 mm was cut from glass B (Table 2) with a thickness of 0.3 mm. The sheet was masked according to the surface areas 16 in the regular pattern of irregular shapes as shown in FIG. 3c. The sheet was then coated with an ITO-film, resulting in a coated area corresponding to the surface area 17 in order to prevent ion-exchange in the coated area. The characteristic dimension of each irregular surface area 16 was 5 μm. After removing the masking of the surface areas 16, the in this example ultrathin glass sheet was submersed into a KNO₃ salt bath and toughened at a temperature of 420° C. for 3 hours. The CS is approximately 900 MPa and the DoL is approximately 35 μm. The refractive index variation is about 0.008. The resulting ultrathin glass article can be applied as an optical diffusor.

### Example 8

Tests have been performed on the change in refractive index Rᵢ due to an Na⁺/K⁺-exchanged surface layer in a glass sheet of glass B (Table 2). It has been found that the change in refractive index Rᵢ linearly depends on the CS resulting from the ion-exchanged surface layer (see Table 4 where a refractive index Rᵢ=0 is assumed at the glass surface):

TABLE 4
Refractive index Rᵢ in dependence of surface
compressive stress CS.

| CS (MPa) | Rᵢ |
|---|---|
| 900 | 0.008 |
| 700 | 0.007 |
| 500 | 0.006 |

The refractive index was measured by a prism coupler (Metricon 2010/M). It has also been found that the refractive index Rᵢ decreases as DoL increases.

What is claimed is:

1. A method for producing a thin glass article, comprising:
providing a thin glass sheet with a first face, a second face, one or more edges joining the first and second faces, and a thickness between the first and second faces, the first and second faces together with the one or more edges form an outer surface; and
applying, non-uniformly, an ion-exchange treatment to the outer surface to produce a non-uniformly ion-exchanged surface layer, the non-uniformly ion-exchanged surface layer having a compressive surface stress and/or a depth of layer that varies between a minimum value and a maximum value over the outer surface.

2. The method according to claim 1, wherein the step of applying, non-uniformly, the ion-exchange treatment to the outer surface comprises applying the ion-exchange treatment such that the minimum value is at most 90% of the maximum value.

3. The method according to claim 1, wherein the step of applying, non-uniformly, the ion-exchange treatment to the outer surface comprises applying the ion-exchange treatment such that the minimum value is at most 30% of the maximum value.

4. The method according to claim 1, wherein the step of applying, non-uniformly, the ion-exchange treatment to the outer surface comprises applying a masking to cover regions of the outer surface prior to applying the ion-exchange treatment, the masking preventing an ion-exchange at the regions.

5. The method according to claim 1, wherein the non-uniformly ion-exchanged surface layer induces a curvature due to the surface compressive stress.

6. The method according to claim 1, wherein the step of applying, non-uniformly, the ion-exchange treatment to the outer surface comprises non-uniformly applying a paste containing alkaline metal salts to the outer surface.

7. The method according to claim 6, further comprising annealing the thin glass sheet after the step of applying.

8. The method according to claim 7, wherein the step of applying, non-uniformly, the ion-exchange treatment further comprises drying the paste at a temperature of 100° C. and 300° C. for 2 to 10 hours prior to the step of annealing.

9. The method according to claim 1, wherein the step of applying, non-uniformly, an ion-exchange treatment to the outer surface comprises applying the ion-exchange treatment only to the one or more edges so that the ion-exchanged surface layer is not present on the first face or the second face.

10. A method for producing a thin glass article, comprising the steps:
providing a thin glass sheet with a first face and a second face, having one or more edges joining the first and the second face, a thickness between the first and the second face, wherein the first and the second face together with the one or more edges form an outer surface of the thin glass sheet; and
applying an ion-exchange treatment to the thin glass sheet to produce the thin glass article, the ion-exchange treatment being non-uniformly applied to the outer surface in order to produce a non-uniformly ion-exchanged surface layer of the thin glass article, such that the non-uniformly ion-exchanged surface layer has an associated compressive surface stress which varies between a minimum and a maximum value over the outer surface and/or a depth of layer which varies between a minimum and a maximum value over the outer surface,
wherein the non-uniform ion-exchange treatment includes non-uniformly applying a paste containing alkaline metal salts to the outer surface and annealing the thin glass sheet.

11. The method according to claim 10, further comprising drying the paste at a temperature of 100° C. and 300° C. for 2 to 10 hours prior to the step of annealing.

12. The method according to claim 10, wherein the non-uniform ion-exchange treatment is applied such that the minimum value of the surface compressive stress is at most 90% of the maximum value.

13. The method according to claim 10, wherein the non-uniform ion-exchange treatment is applied such that the minimum value of the surface compressive stress is at most 50% of the maximum value.

14. The method according to claim 10, wherein the non-uniform ion-exchange treatment is applied such that the minimum value of the surface compressive stress is at most 30% of the maximum value.

15. The method of claim 10, wherein the non-uniform ion-exchange treatment is selectively applied to one or more designated surface areas on the outer surface in order to produce one or more surface areas of a first kind and one or more surface areas of a second kind, wherein the surface compressive stress and/or the depth of layer is different in the one or more surface areas of the first and second kinds.

16. The method of claim 15, wherein the non-uniform ion-exchange treatment is applied such that the surface compressive stress and/or the depth of layer correspond to the respective maximum value in the one or more surface areas of the first kind and to the respective minimum value in the one or more surface areas of the second kind.

17. The method according to claim 10, wherein the paste comprises alkaline metal salts selected from a group consisting of NaNO3, Na2CO3, NaOH, Na2SO4, NaF, Na3PO4, Na2SiO3, Na2Cr2O7, NaCl, NaBF4, Na2HPO4, K2CO3, KOH, KNO3, K2SO4, KF, K3PO4, K2SiO3, K2Cr2O7, KCl, KBF4, K2HPO4, CsNO3, CsSO4, and CsCl.

18. The method according to claim 10, wherein the non-uniform ion-exchange treatment comprises controlling a slow ion-exchange rate to achieve the ion-exchange surface layer with the maximum value of the depth of layer of equal to or less than 50 μm and the maximum value of the surface compressive stress in a range from 10 MPa to 1200 MPa.

19. The method according to claim 18, wherein the depth of layer is equal to or less than 3 μm.

20. The method according to claim 10, wherein the non-uniformly ion-exchanged surface layer induces a curvature due to the surface compressive stress.
